(19) United States
(12) Patent Application Publication
(10) Pub. No.: US 2005/0129460 A1
(43) Pub. Date: Jun. 16, 2005

(54) Modular frame corners

(75) Inventors: Merle D. Medcalf, Harrah, OK (US); Michael D. Medcalf, Harrah, OK (US)

Correspondence Address: DUNLAP, CODDING & ROGERS P.C., PO BOX 16370, OKLAHOMA CITY, OK, 73113, US

(73) Assignee: Excell Products, Inc.

(21) Appl. No.: 11/010,711

(22) Filed: Dec. 13, 2004

Related U.S. Application Data
(60) Provisional application No. 60/528,614, filed on Dec. 11, 2003.

(51) Int. Cl. F16D 1/00

(52) U.S. Cl. 403/403

(57) ABSTRACT

A modular frame corner for joining adjacently disposed frame members. The modular frame corner includes a first corner piece, a second corner piece and a connector assembly for connecting the first and second corner pieces. The connector assembly includes a male connector and a female connector adapted to receive the male connector. The female connector is provided with a length substantially corresponding to the distance between the first and second corner pieces when same are in a connected position so that the female connector provides a substantially uniform and unbroken surface between the first and second corner pieces.

### CROSS REFERENCE TO RELATED APPLICATIONS

This application claims benefit of U.S. Provisional Application 60/528,614, filed Dec. 11, 2003, which is incorporated herein by reference in its entirety.

### STATEMENT REGARDING FEDERALLY SPONSORED RESEARCH OR DEVELOPMENT

Not applicable.

### BACKGROUND OF THE INVENTION

1. Field of the Invention

The present invention generally relates to a corner piece for a frame and, more particularly, to a modular corner piece for frames intended to be used for advertising and display purposes.

2. Brief Description of Related Art

It is previously known to manufacture frames in long segments or strips and thereafter cut them to the desired length in order to constitute the sides of the frames. The profiles are interconnected via corner pieces so as to form a complete frame.

Frames for advertising and information purposes often are used only once, e.g. at fairs, exhibitions and the like. Therefore, it is desirable that the frames be inexpensive. In this respect, extruded profiles constitute an inexpensive element manufactured by tools while, on the other hand, the frame corners are more expensive because tools with mobile parts are required and also because the detail proper will become more homogenous and requires more material.

Corner pieces have hereto been provided which are composed of two identical corner parts interconnected by a fastening assembly in such a way that the legs and intermediate part of the corner piece have a first symmetry plane coinciding with the plane of the frame and a second symmetry plane or bisector plane through the bisector to the angle between the corner piece legs so that the second symmetry plane is perpendicular to the first symmetry plane.

While corner pieces and modular frames of the prior art have met with some success, new and improved corner pieces and modular frames are constantly being sought which are inexpensive to manufacture and which constitute an improvement in modular frame construction. It is to such a modular frame and modular corner pieces for such frames that the present invention is directed.

### SUMMARY OF THE INVENTION

The present invention relates to a modular frame corner for joining adjacently disposed frame members wherein each of the frame members is provided with at least one elongated passageway extending therethrough. The modular frame corner includes a first corner piece, a second corner piece connectable to the first corner piece, and a connector assembly for connecting the first and second corner pieces. The first corner piece is provided with a first extension member, a second extension member and an intermediate member disposed therebetween. Similarly, the second corner piece is provided with a first extension member, a second extension member and an intermediate member disposed therebetween. The first and second extension members of the first corner piece are matingly disposable within a portion of a passageway of a multi-component frame member and the first and second extension members of the second corner piece are matingly disposable within a portion of a passageway of an adjacently disposed frame member of the frame.

The connector assembly, which connects the first corner piece to the second corner piece of the modular frame corner is provided with a male connector extending from the intermediate member of the second corner piece and a female connector extending from the intermediate member of the first corner piece. The female connector, which is adapted to matingly receive the male connector, is provided with a length substantially corresponding to the distance between the first and second corner pieces when same are in an assembled position so that the female connector provides a substantially uniform and unbroken surface between the first and second corner pieces.

### DESCRIPTION OF THE PREFERRED EMBODIMENTS

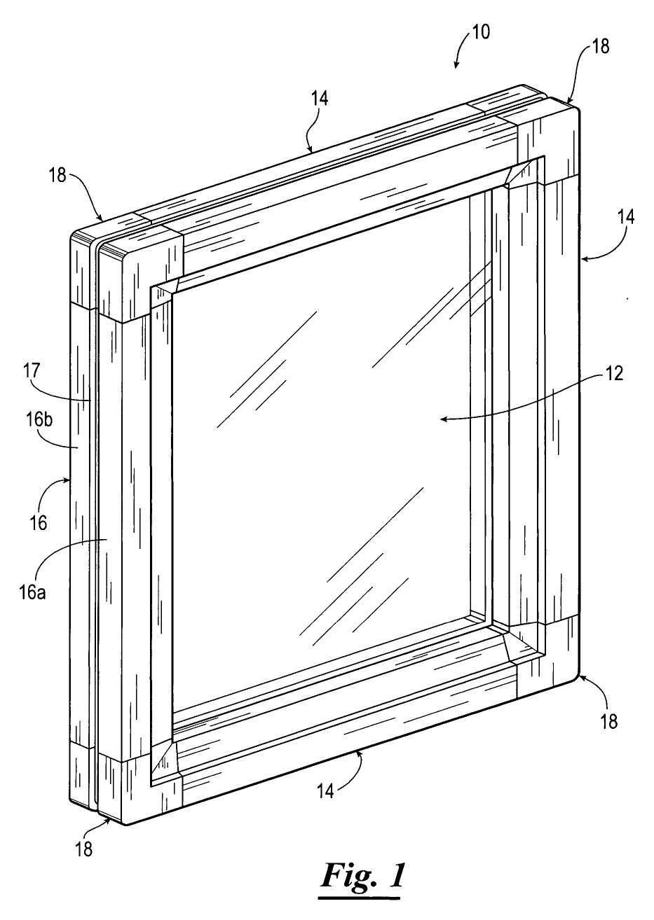

FIG. 1 is a perspective view of a frame having modular frame corners constructed in accordance with the present invention.

FIG. 2 is an exploded fragmental perspective view of one of the modular frame corners of FIG. 1.

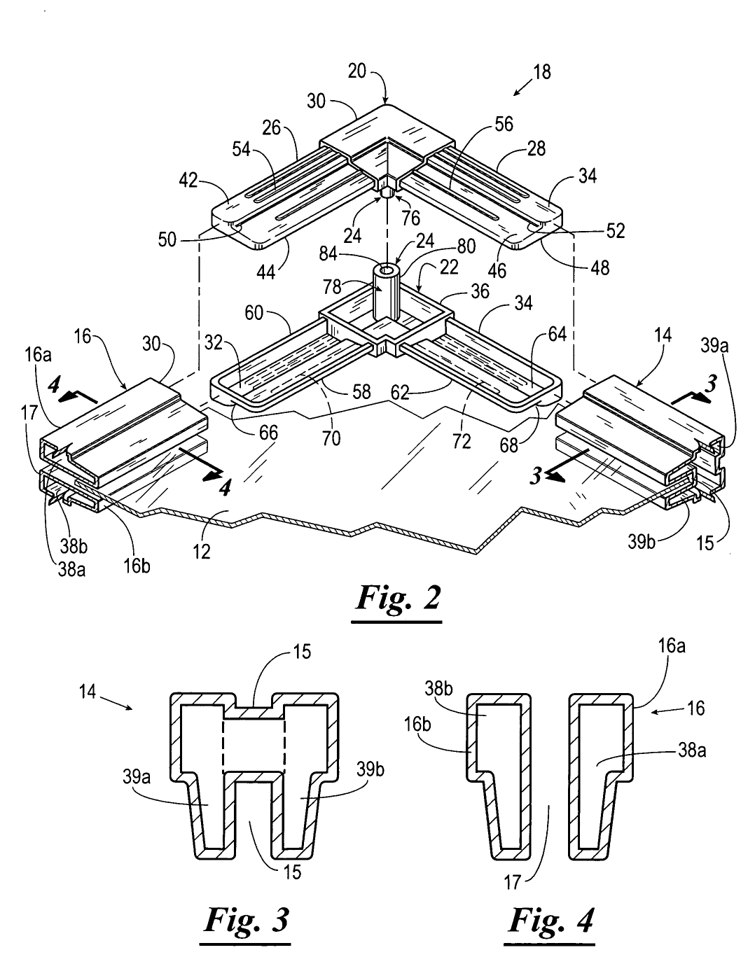

FIG. 3 is a cross-sectional view of a frame member of FIG. 2 taken along line 3-3 thereof.

FIG. 4 is a cross-sectional view of a multi-component frame member of FIG. 2 taken along line 4-4 thereof.

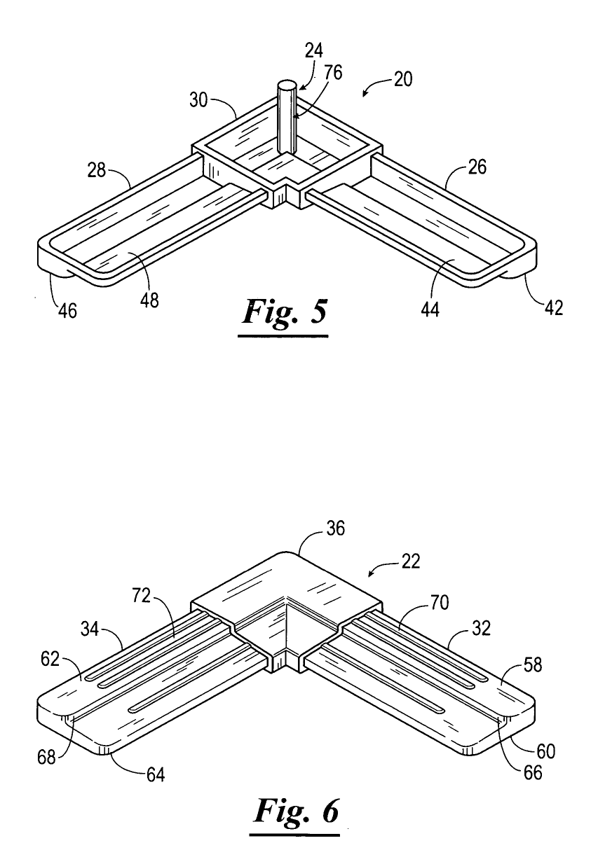

FIG. 5 is a perspective view of one of the corner pieces of the modular frame corner of the present invention illustrating a second side thereof.

FIG. 6 is a perspective view illustrating a first side of the second corner piece of the modular frame corner of the present invention.

### DETAILED DESCRIPTION

Referring now to the drawings, and more particularly to FIG. 1, shown therein and designated by the general reference numeral 10 is a frame for securing and displaying a frameable object 12. The frame 10 includes three frame members 14, each of which is provided with a groove 15 (FIG. 3), and a multi-component frame member 16 formed of two spatially disposed frame members 16a and 16b which define a slot 17 therebetween (FIG. 4). The three frame members 14 and the multi-component frame 16 are interconnected with four modular frame corners 18 to provide the frame 10. While the frame 10 has been shown as having a substantially rectangular configuration, it should be understood that the frame 10 may have any configuration. For example, the configuration of the frame 10 may be circular, elliptical, triangular, hexagonal or any polygonal shape as long as the configuration of the frame 10 corresponds to the configuration of the frameable object 12 or the configuration of a matting of the frameable object 12. Furthermore, the frame 10 may include any number of modular frame corners 18, frame members 14, and multi-component frame members 16 to accommodate the configuration of the frame 10. For purposes of brevity, only one modular frame corner 18 and its interconnection with one of the frame members 14 and the multi-component frame member 16 will be described in detail hereinafter with reference to FIGS. 2-4.

Referring more particularly to FIG. 2, the modular frame corner 18 includes a first corner piece 20 and a second corner piece 22. The first corner piece 20 is connectable to the second corner piece 22 via a connector assembly 24 in a manner hereinafter described in detail. The first corner piece 20, the second corner piece 22 and the connector assembly 24 of the modular frame corner 18 are preferably constructed of a suitable material which provides sufficient rigidity to the modular frame corner 18, and thus the frame 10, to secure the frameable object 12. For example, the first corner piece 20, the second corner piece 22 and the connector assembly 24 of the modular frame corner 18 may be constructed from plastic, wood, metal, and/or combinations thereof. It is to be understood that the first and second corner pieces 20 and 22 of the modular frame corner 18, as well as the connector assembly 24 for connecting the first corner piece 20 to the second corner piece 22, may be formed by any process known in the art. For example, the first corner piece 20, the second corner piece 22 and the connector assembly 24 of the modular frame corner 18 may be formed utilizing an injection molding process, an extrusion process, a vacuum process, combinations thereof, or any other suitable process. Since the above-mentioned processes are well know in the art, no further comments concerning their use in forming the first corner piece 20, the second corner piece 22 and the connector assembly 24 of the modular frame corner 18 are deemed necessary in order to teach a person skilled in the art how to manufacture the modular frame corner 18.

Referring now the FIGS. 2 and 5, the first corner piece 20 of the modular frame corner 18 includes a first extension member 26 and a second extension member 28 joined by an intermediate member or portion 30. Similarly, the second corner piece 22 of the modular frame corner 18 (FIGS. 2 and 5) includes a first extension member 32 and a second extension member 34 joined by an intermediate member or portion 36. When the first corner piece 20 and the second corner piece 22 are connected, the first extension member 26 of the first corner piece 20 and the first extension member 32 of the second corner piece 22 are disposable within passageways or hollow portions 38a and 38b of the adjacently disposed frame member 16a and 16b, respectively, of the multi-component frame member 16 (FIGS. 2 and 4); and the second extension member 28 of the first corner piece 20 and the second extension member 34 of the second corner piece 22 are disposable within passageways or hollow portions 39a and 39b of the adjacently disposed frame member 14 (FIGS. 2 and 3). That is, when constructing the frame 10 (FIG. 1), the first corner piece 20 is connected to the second corner piece 22 via the connector assembly 24 so that the first extension members 26 and 32 of the first and second corner pieces 20 and 22, respectively, can be frictionally secured in the passageways or hollow portions 38a and 38b of the frame members 16a and 16b of the multi-component frame member 16 and the second extension members 28 and 34 of the first and second corner pieces 20 and 22, respectively, can be frictionally secured in passageways or hollow portions 39a and 39b of the adjacent end portion 40 of the frame member 14. It should be noted that the frame members 16a and 16b of the multi-component frame member 16 are disposed a distance apart so as to define the slot 17 through which the framable object 12 can be passed for insertion of the frameable object 12 into the frame 10 or during removal of the frameable object 12 from the frame 10. In addition, the groove 15 is provided in each of the frame members 14 for receiving an edge portion of the frameable object 12 substantially as shown in FIG. 2.

The first extension member 26 and the second extension member 28 of the first corner piece 20 are substantially perpendicular to one another (FIGS. 2 and 5) and the first extension member 32 and the second extension member 34 of the second corner piece 22 are likewise substantially perpendicular to one another (FIGS. 2 and 5) such that the first corner piece 20 and the second corner piece 22 cooperate with the connector assembly 24, the adjacently disposed frame member 14 and the adjacently disposed frame member 16a and 16b of the multi-component frame member 16 to form one corner of the rectangular-shaped frame 10 of FIG. 1. It should be noted that although the first extension member 26 and the second extension member 28 of the first corner piece 20 and the first extension member 32 and second extension member 34 of the second corner piece 22 are shown to be substantially perpendicular to one another, the angular disposition of the first extension member 26 and the second extension member 28 of the first corner piece 20 relative to the first extension member 32 and the second extension member 34 of the second corner piece 22 may vary and will be dependent on the configuration of the frame 10. Thus, the angle between the first extension member 26 and the second extension member 28 of the first corner piece 20 and the angle between the first extension member 32 and the second extension member 34 of the second corner piece 22 may be an obtuse angle, an acute angle, or arcuate shaped so long as the first extension member 26 and the second extension member 28 of the first corner piece 20 can be joined by the intermediate member 30 of the first corner piece 20 and the first extension member 32 and the second extension member 34 of the second corner piece 22 can be joined by the intermediate member 36 of the second corner piece 22. In an alternate embodiment of the present invention, the first corner piece or the second corner piece of the modular frame corner may each include more than two extension members to form a plurality of frames (not shown).

The first extension member 26 of the first corner piece 20 has a first surface 42 and a second surface 44; and the second extension member 28 of the first corner piece 20 has a first surface 46 and a second surface 48. The first surface 42 of the first extension member 26 of the first corner piece 20 is provided with a recessed or step-down portion 50. Similarly, the first surface 46 of the second extension member 28 of the first corner piece 20 is provided with a recessed or step-down portion 52. A plurality of ridges 54 extend lengthwise along at least a portion of the first surface 42 of the first extension member 26 substantially as shown. A plurality of ridges 56 also extend lengthwise along at least a portion of the first surface 46 of the second extension member 28 substantially as shown.

The first extension member 32 of the second corner piece 22 and the second extension member 34 of the second corner piece 22 are similar in construction and function as the first and second extension members 26 and 28 of the first corner piece 20 hereinbefore described. That is, the first extension member 32 of the second corner piece 22 is provided with a first surface 58 and a second surface 60; and the second extension member 34 of the second corner piece 22 is provided with a first surface 62 and a second surface 64. The first surface 58 of the first extension member 32 of the second corner piece 22 is provided with a recessed or step-down portion 66; and the first surface 62 of the second extension member 34 of the second corner piece 22 is also provided with a recessed or step-down portion 68. A plurality of ridges 70 extend lengthwise along at least a portion of the first surface 58 of the first extension member 32 in a similar manner as the ridges 54 extend along the first surface 42 of the first extension member 26 of the first corner piece 20 as shown in FIG. 2. A plurality of ridges 72 extend lengthwise along at least a portion of the first surface 62 of the second extension member 34 in a similar manner as the ridges 56 extend along the first surface 46 of the second extension member 28 of the first corner piece 20 substantially as shown in FIG. 2.

It should be understood that the cross-sectional configuration of the first extension member 26 of the first corner piece 20 and the first extension member 32 of the second corner piece 22 substantially correspond to the cross-sectional configuration of the passageways or hollow portions 38a and 38b of the frame member 16a and 16b, respectively, of the multi-component frame member 16; and the cross-sectional configuration of the second extension member 28 of the first corner piece 20 and the second extension member 34 of the second corner piece 22 substantially correspond to the cross-sectional configuration of the passageways or hollow portions 39a and 39b, respectively, of the frame member 14. It should be noted that the first extension member 26 of the first corner piece 20 and the first extension member 32 of the second corner piece 22, as well as the second extension member 28 of the first corner piece 20 and the second extension member 34 of the second corner piece 22, may be provided with any cross-sectional configuration as long as the first extension members 26 and 32 of the first and second corner pieces 20 and 22, respectively, can be matingly disposed in and frictionally stabilized in the passageways or hollow portions 38a and 38b of the frame members 16a and 16b of the multi-component frame member 16, or in the passageways or hollow portions 39a and 39b of an adjacently disposed frame member 14, and the second extension members 28 and 34 of the first and second corner pieces 20 and 22, respectively, can be matingly disposed in and frictionally stabilized in frame member 14 or the frame members 16a and 16b of the multi-component frame member 16, as the case may be.

As previously stated, the first and second corner pieces 20 and 22 are connected via the connector assembly 24. The connector assembly 24 includes a male connector 76 and a female connector 78 constructed to matingly receive the male connector 76. The male connector 76 extends from the intermediate member 30 of the first corner piece 20 (FIG. 5); and the female connector 78 extends from the intermediate member 36 of the second corner piece 22 (FIG. 2). The female connector 78 has a lug or body member 80 having an opening or passageway 84 for receiving the male connector 76. That is, the female connector 78 of the second corner piece 22 is adapted to matingly receive the male connector 76 of the first corner piece 20 thereby forming a connection between the first corner piece 20 and the second corner piece 22. The lug or body member 80 of the female connector 78 of the second corner piece 22 is provided with a length substantially corresponding to the distance between the first corner piece 20 and the second corner piece 22 when same are in the assembled condition so as to provide the connector assembly 24 with a substantially uniform and unbroken surface. The configuration of the male connector 76 and the female connector 78 may vary, as long as the female connector 78 is adapted to matingly receive the male connector 76 and the female connector 78 provides a substantially uniform and substantially unbroken surface between the first corner piece 20 and the second corner piece 22 when same are in an assembled, connected condition.

Referring again to FIG. 1, the frame 10 is shown as having three frame members 14 and one multi-component frame member 16 interconnected with four modular frame corners 18. The frame members 14 and the multi-component frame member 16 function in an essentially similar manner by interconnecting with a plurality of modular frame corners 18 to form the frame 10. It should be understood that the frame 10 may consist of a combination of any number of frame members 14 and multi-component frame members 16 so long as the interconnection of the frame members 14 and the multi-component frame member 16, in combination with the modular frame corners 18, provide sufficient rigidity to the frame 10 while enabling the frameable object 12 to be secured within the confines of the frame 10. For example, the frame 10 may include four frame members 14 interconnected with four modular frame corners 18 to secure and display the frameable object 12. The aforesaid combination and number of frame members 14 interconnected with the modular frame corners 18 are only representative and not limiting.

Referring more particularly to FIG. 3, the frame member 14 is shown as having a substantially H-shaped cross-sectional configuration. The frame member 14 is provided with the passageways or hollow portions 39a and 39b for matingly receiving the second extension members 28 and 34 of the first and second corner pieces 20 and 22, respectively. The groove 15 extends inwardly into the frame member 14 a distance sufficient to secure the object 14 within the frame 10 in a stable position.

Referring more particularly to FIG. 4, the multi-component frame member 16 includes the frame member 16a and 16b which are substantially mirror images of one another. In a connected position the frame members 16a and 16b of the multi-component frame member 16 are disposed in a substantially parallel relationship so that the slot 17 is formed therebetween. The slot 17 between the frame members 16a and 16b permits the frameable object 12 to be slidingly inserted into and removed from the confines of the frame 10.

It will be appreciated that the components of the frame 10 having the modular frame corners 18 as described herein are versatile and can be used to form many different configurations and sizes of the frame 10. It will also be appreciated that while the frame 10 is shown to have three frame members 14 and one multi-component frame member 16 interconnected with four modular frame corners 18, the frame 10 may consist of any number of frame members 14 or multi-component frame members 16 as long as the frame 10 rigidly secures and displays the frameable object 12.

From the above description, it is clear that the present invention is well adapted to carry out the objective and attain the advantages mentioned herein as well as those inherent in the invention. While presently preferred embodiments of the invention have been described for purposes of the disclosure, it will be understood that numerous changes may be made which will readily suggest themselves to those skilled in the art and which are accomplished within the spirit of the invention disclosed.

1. A modular frame corner for joining adjacently disposed frame members, the modular frame corner comprising:
a first corner piece having a first extension member, a second extension member and an intermediate member disposed therebetween;
a second corner piece connectable to the first corner piece, the second corner piece having a first extension member, a second extension member and an intermediate member disposed therebetween; and
a connector assembly for connecting the first and second corner pieces,
the connector assembly comprising:
a male connector extending from the intermediate portion of the second corner piece; and
a female connector extending from the intermediate portion of the first corner piece and adapted to matingly receive the male connector, the female connector having a length substantially corresponding to the distance between the first and second corner pieces when same are in a assembled position whereby the female connector provides a substantially uniform and unbroken surface between the first and second corner pieces when the male connector is matingly connected to the female connector and the first and second corner pieces are in a connected position.

2. The modular frame corner of claim 1 wherein each of the frame members is provided with at least one elongated passageway extending therethrough, and wherein, when the first and second corner pieces are connected via the connector assembly, the first extension member of the first and second corner pieces are disposable within a portion of the elongated passageway of the adjacently disposed frame member and frictionally secured therein so as to stabilize the connection of the first extension member of the first and second corner pieces with the adjacently disposed frame member and the second extension members of the first and second corner pieces are disposable within a portion of the elongated passageway of the adjacently disposed frame member and frictionally secured therein so as to stabilize the connection of the second extension members of the first and second corner pieces with the adjacently disposed frame member.

3. The modular frame corner of claim 2 wherein at least one of the frame members is a multi-component frame member and wherein the multi-component frame member comprises:
a first frame member and a spatially disposed second frame member, each of the first and second frame members having an elongated passageway extending therethrough, the first extension member of the first corner piece disposable within a portion of the elongated passageway of the first frame member and the first extension member of the second corner piece disposable within a portion of the elongated passageway of the second frame member whereby the first extension members of the first and second corner pieces are frictionally connected to the first and second frame members.

4. The modular frame corner of claim 3 wherein the first extension members of the first and second corner pieces are provided with a cross-sectional configuration substantially corresponding to the cross-sectional configuration of the elongated passageways of the first and second frame members.

5. The modular frame corner of claim 4 wherein the first and second extension members of the first and second corner pieces are each provided with an upper surface and a lower surface and the upper surface of each of the first and second extension members of the first and second corner piece is provided with at least one ridge to enhance frictional engagement with, and stabilization of, the first extension members within the elongated passageways of the first and second frame members of an adjacently disposed multi-component frame member and to enhance frictional engagement with, and stabilization of, the second extension members within the elongated passageway of an adjacently disposed frame member.

6. The modular frame corner of claim 2 wherein the first extension member of the first and second corner pieces are provided with a cross-sectional configuration substantially corresponding to the cross-sectional configuration of the elongated passageway of an adjacently disposed frame member and wherein the second extension members of the first and second corner pieces are provided with a cross-sectional configuration substantially corresponding to the cross-sectional configuration of the elongated passageway of the adjacently disposed frame member or the cross-sectional configuration of elongated passageways of the first and second frame members of an adjacently displaced multi-component frame member.

7. The modular frame corner of claim 6 wherein the first and second extension members of the first and second corner pieces are each provided with at least one ridge on at least one surface thereof for stabilizing and enhancing frictional engagement of the first and second corner pieces with adjacently disposed frame members or an adjacently displaced multi-component frame member when the first and second extension members of the first and second corner pieces are disposed within a portion of the passageway of the adjacently disposed frame members or the adjacently displaced multi-component frame member.

8. A modular frame corner for joining adjacently disposed frame members wherein each of the frame members is provided with an elongated passage way extending therethrough, the modular frame corner comprising:
a first corner piece having a first extension member, a second extension member and an intermediate member disposed therebetween, each of the first and second extension members having an upper surface and a lower surface, the upper surface of each of the first and second extension members having a recessed portion formed therein and a plurality of ridges for frictionally engaging a portion of an adjacently disposed frame member and stabilizing the interconnection of the first corner piece with an adjacently disposed end portion of the frame member when the first corner piece is matingly disposed within a portion of the passageway of the adjacently disposed frame member;
a second corner piece connectable to the first corner piece, the second corner piece having a first extension member, a second extension member and an intermediate member disposed therebetween, each of the first and second extension members of the second corner piece having an upper surface and a lower surface, the upper surface of each of the first and second extension members having a recessed portion formed therein and a plurality of ridges for frictionally engaging a portion of an adjacently disposed frame member, stabilizing the interconnection of the second corner piece with an adjacently disposed end portion of the frame member; and
a connector assembly for connecting the first and second corner pieces, the connector assembly comprising:
a male connector extending from the intermediate portion of the second corner piece; and
a female connector extending from the intermediate portion of the first corner piece and adapted to matingly receive the male connector, and the female connector having a length substantially corresponding to the distance between the first and second corner pieces when same are in an assembled position whereby the female connector provides a substantially uniform and unbroken surface between the first and second corner pieces when the male connector is matingly connected to the female connector and the first and second corner pieces are in a connected position.
